(19) United States
(12) Patent Application Publication
(10) Pub. No.: US 2006/0284794 A1
(43) Pub. Date: Dec. 21, 2006

(54) Electrophoretic display activation with symmetric data frames

(76) Inventors: Mark T. Johnson, Geelgieter 16 (NL); Goufu Zhou, Galmheuvel 4 (NL); Masaru Yasui, Hyogo (JP)

Correspondence Address: PHILIPS INTELLECTUAL PROPERTY & STANDARDS, P.O. BOX 3001, BRIARCLIFF MANOR, NY, 10510, US

(21) Appl. No.: 10/570,215

(22) PCT Filed: Aug. 30, 2004
(86) PCT No.: PCT/IB04/51606

§ 371 Date: Feb. 28, 2006

Related U.S. Application Data
(60) Provisional application No. 60/501,123, filed on Sep. 8, 2003.
(60) Provisional application No. 60/553,014, filed on Mar. 12, 2004.

(51) Int. Cl. G09G 3/20

(52) U.S. Cl. 345/58

(57) ABSTRACT

A system implements a method of activating an electrophoretic display (10). First, the system receives image information (14) and generates a plurality of symmetric data frames (70) from the received image information. The symmetric data frames include symmetric pixel data (72) and substantially symmetric data-frame times (74). Thereafter, the system addresses the electrophoretic display (10) based on the symmetric pixel data and the substantially symmetric data-frame times.

This invention relates generally to electrophoretic displays, and more specifically to activation of a matrix of electrophoretic pixels.

Electrophoretic display media are non-volatile systems used to store digital information in the form of viewable text or images. Electrophoretic displays are generally characterized by the movement of polarized or charged particles in an applied electric field, and can be bi-stable with display elements having first and second display states that differ in at least one optical property such as lightness or darkness of a color. In recently developed electrophoretic displays, the display states occur after microencapsulated particles in the electronic ink have been driven to one state or another by an electronic pulse of a finite duration, and the driven state persists after the activation voltage has been removed. Such displays can have attributes of good brightness and contrast, wide-viewing angles, state stability for two or more states, and low power consumption when compared with liquid crystal displays (LCDs). An exemplary electrophoretic display with microcapsules containing either a cellulosic or gel-like phase and a liquid phase, or containing two or more immiscible fluids are described in “Process for Creating an Encapsulated Electrophoretic Display,” Albert et al., U.S. Pat. No. 6,067,185 issued May 23, 2000 and “Multi-Color Electrophoretic Displays and Materials for Making the Same,” Albert et al., U.S. Pat. No. 6,017,584 issued Jan. 25, 2000.

Electrophoretic displays receive image data and may be addressed by driving an active matrix located on the frontside or backside of the display. The active-matrix displays have intrinsic addressing schemes such as fixed coordinates on a pixel-by-pixel grid to accurately write text and graphics. An exemplary electrophoretic display unit comprises a layer of electrophoretic ink with a transparent common electrode on one side, and a substrate or a backplane having pixel electrodes arranged in rows and columns. The crossing between a row and a column is associated with an image pixel that is formed between a pixel electrode and a portion of the common electrode. The pixel electrode connects to the drain of a transistor, of which the source is electrically coupled to a column electrode and of which the gate is electrically connected to a row electrode. This arrangement of pixel electrodes, transistors, row electrodes and column electrodes jointly forms an active matrix. A row driver supplies a row selection signal via the row electrodes to select a row of pixels and a column driver supplies data signals to the selected row of pixels via the column electrodes and the transistors. The data signals on the column electrodes correspond to data to be displayed, and form, together with the row selection signal, driving signals for driving one or more pixels in the electrophoretic display.

Electrophoretic ink, also referred to as electronic ink or e-ink, is positioned between the transparent common electrode and the pixel electrodes and typically comprises multiple microcapsules having a diameter between about 10 and 50 microns. In one example of a black-and-white display, each microcapsule comprises positively charged white particles and negatively charged black particles suspended in a fluid. When a positive electric field is applied from the transparent common electrode to the pixel electrode, the negatively charged black particles move towards the common electrode and the pixel becomes darker to a viewer. Simultaneously, the positively charged white particles move towards the pixel electrode on the backplane, away from the viewer's sight.

Applying an activation voltage between pixel electrodes and the common electrode for specified periods of time generally creates grayscale in an active-matrix monochromatic electropboretic display. For a characteristic active-matrix electrophoretic display of current art, pulse-width modulation on a frame-by-frame basis may be used, generating three voltage levels: −15 volts, +15 volts and 0 volts. A relatively slow frame refresh rate, such as a frame time of 20 milliseconds for a 600-row display with 800 or more columns, limits the number of gray levels and grayscale accuracy, the grayscale being defined generally as the product of activation voltage and frame time. With a relatively long switching time on the order of 500 milliseconds for black to white or white to black transitions, up to twenty-five data frames are needed to switch the ink. Due to all frames each having the same fixed duration, the driving of the electrophoretic display unit is inflexible. Gray-level accuracy and the number of gray values is limited, with the difference between two subsequent gray values being rather large. Because a higher frame rate for electrophoretic displays is desirable for increasing grayscale resolution, various approaches have been suggested for achieving higher frame rates.

One suggested solution is to create a variable high-frame rate by a variable row selection time combined with a high clock rate. This is useful when the same frame period is used for the entire driving waveform.

Another suggested solution for overcoming limited grayscale resolution is to include a row delay variable frame-time mode. The row delay variable frame-time mode varies frame time using row delays that can have, for example, a shorter frame time for one particular frame when compared to the frame time for an immediately prior frame. Because the first frame is scanned at a slower rate than the second frame, the pixels in the first row maintain their activation voltage for a longer period of time during the first frame than pixels in the last row. The pixels in the last row may therefore transition to a different gray level than the those in the first row and this so-called vertical crosstalk, the gradual change in the gray level, is visible in displays driven using the row delay variable frame-time mode. Crosstalk has been a problem in various types of displays having liquid crystals, electrophoretic suspensions or electrochromic materials, as described in “Display Device with Mirror-Symmetrical Pixels,” Strik, U.S. Pat. No. 5,847,684 granted Dec. 8, 1998.

Preferably, different frame periods can be used for dissimilar parts of the waveform so that shorter frame periods may be employed for short periods of microcapsule particle shaking or preconditioning to minimize the influence of image history, while longer frame periods may be used for resetting the display and to apply data pulses with reduced power consumption.

A high-resolution grayscale image for an electrophoretic display requires a large number of gray levels and high gray-scale accuracy while eliminating vertical crosstalk. Therefore, what is needed is a method of and system for driving an electrophoretic display with variable frame times that improve display uniformity and avoids the presence of vertical crosstalk, and that creates the shortest possible update time for the entire display, thereby providing an image having the most accurate and greatest possible numbers of gray levels while consuming minimal power. In addition, a desirable method for driving an electrophoretic display also needs to be efficient with the number of required frames to limit the total image update time while offering the required uniformity, resolution and accuracy of the image.

One form of the present invention is a method of activating an electrophoretic display while reducing vertical crosstalk. Image information is received and a plurality of symmetric data frames is generated from the received image information. The symmetric data frames may comprise either image-dependent or image-independent information. The symmetric data frames include symmetric pixel data and substantially symmetric data-frame times. The electrophoretic display is addressed based on the symmetric pixel data and the substantially symmetric data-frame times.

Another form of the present invention is a system for activating an electrophoretic display including an electrophoretic pixel array disposed on a backplane, means for generating a plurality of symmetric data frames from the received image information including symmetric pixel data and substantially symmetric data-frame times, and means for addressing the electrophoretic pixel array based the symmetric pixel data and the substantially symmetric data-frame times.

Another form of the present invention is an electrophoretic display including an electrophoretic pixel array disposed on a backplane, a row driver, a column driver, and a controller. The row driver is electrically connected to rows of the electrophoretic pixel array. The column driver is electrically connected to columns of the electrophoretic pixel array. The controller is electrically connected to the row driver and the column driver. The controller generates a plurality of symmetric data frames from received image information including symmetric pixel data and substantially symmetric data-frame times. The controller addresses the electrophoretic display based on the symmetric pixel data and the substantially symmetric data-frame times to activate at least one electrophoretic pixel in the electrophoretic pixel array.

The aforementioned forms as well as other forms and features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

Various embodiments of the present invention are illustrated by the accompanying figures, wherein:

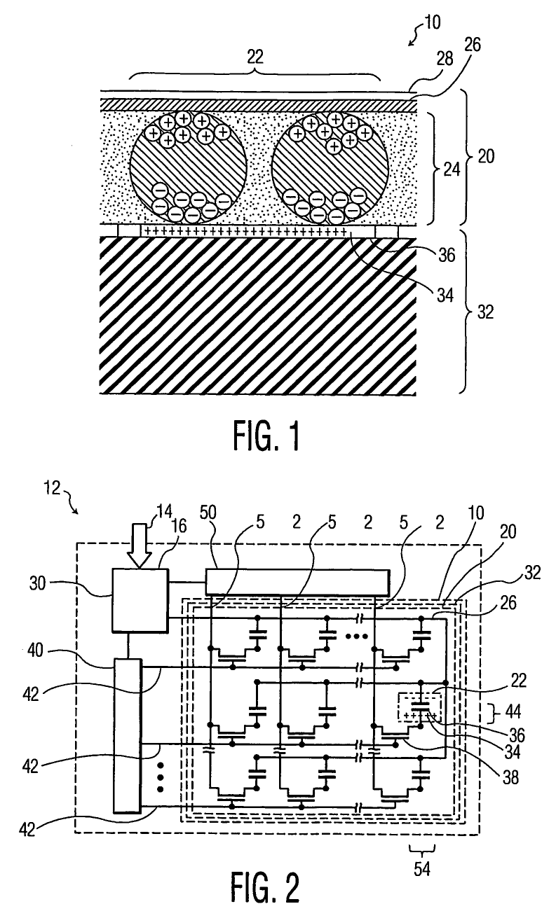

FIG. 1 is an illustrative cross-sectional view of a portion of an electrophoretic display, in accordance with one embodiment of the present invention;

FIG. 2 is a schematic view of a system for activating an electrophoretic display, in accordance with one embodiment of the present invention;

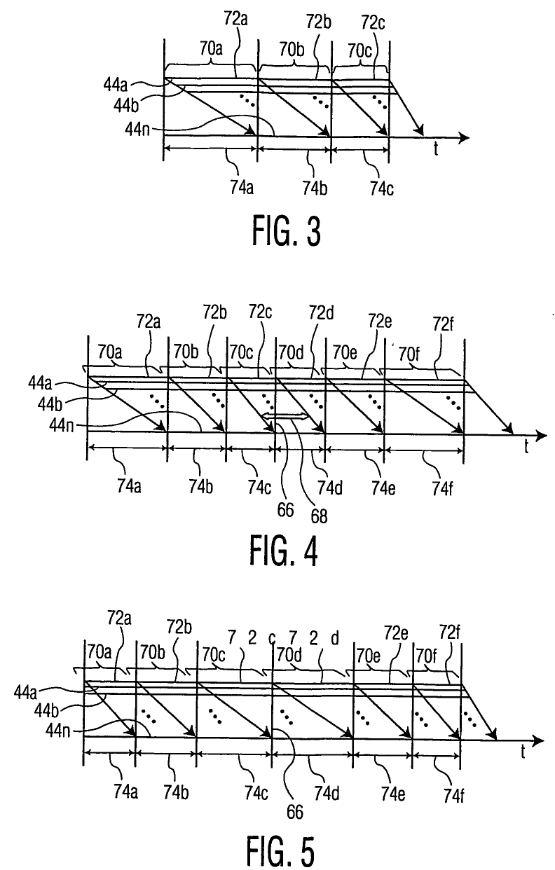

FIG. 3 is a timing diagram illustrating a method of activating an electrophoretic display using variable data-frame times;

FIG. 4 is a timing diagram illustrating a method of activating an electrophoretic display using symmetric data frames, in accordance with one embodiment of the present invention;

FIG. 5 is a timing diagram illustrating a method of activating an electrophoretic display using symmetric data frames, in accordance with another embodiment of the present invention;

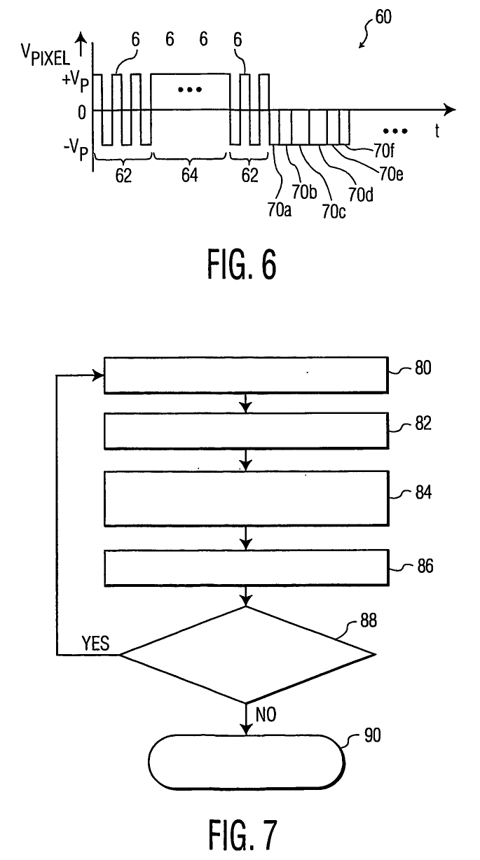

FIG. 6 is a driving waveform for activating an electrophoretic display with symmetric data frames in an image-dependent portion of the driving waveform, in accordance with one embodiment of the present invention; and

FIG. 7 is a flow diagram for a method of activating an electrophoretic display, in accordance with one embodiment of the present invention.

FIG. 1 is an illustrative cross-sectional view of a portion of an electrophoretic display 10, in accordance with one embodiment of the present invention. Electrophoretic display 10 includes an electrophoretic pixel array 20 having an addressable array or matrix of electrophoretic pixels 22.

In an exemplary embodiment, electrophoretic display 10 comprises a layer of electrophoretic ink 24 disposed on a backplane 32. Electrophoretic ink 24 may comprise one of several commercially available electrophoretic inks, commonly referred to as electronic ink or e-ink. Electrophoretic ink 24 comprises, for example, a thin electrophoretic film with millions of tiny microcapsules in which positively charged white particles and negatively charged black particles are suspended in a clear fluid. Other variants are possible, such as positively charged black particles and negatively charged white particles, or colored particles of one polarity and black or white particles of the opposite polarity, or colored particles in a white colored fluid, or particles in a gaseous fluid.

The encapsulated electrophoretic particles can be rotated or translated by application of an electric field into a desired orientation. The electrophoretic particles reorient or migrate along field lines of the applied electric field and can be switched from one optical state to another based on the direction and intensity of the electric field and the time allowed to switch states. For example, when a negative electric field is applied to the display, the white particles move to the top of the microcapsules where they become visible to the user. This makes the surface appear white at the top position or outer surface of the microcapsules. At the same time, the electric field pulls the black particles to the bottom of the microcapsules where they are hidden. When the process is reversed, the black particles appear at the top of the microcapsules, which makes the surface appear dark at the surface of the microcapsules. When the activation voltage is removed, a fixed image remains on the display surface.

Electrophoretic ink 24 may contain an array of colored electrophoretic materials to allow the generation and display of colored images such as an array of magenta, yellow, and cyan electrophoretic materials, or an array of red, green, blue and black electrophoretic materials. Alternatively, the electrophoretic display may include an array of colored filters such as red, green and blue positioned above black and white electrophoretic pixels. A matrix of rows and columns allows each electrophoretic pixel 22 to be individually addressed and switched into the desired optical state such as black, white, gray, or another prescribed color. Each electrophoretic pixel 22 may include one or more microcapsules, related in part to the size of the microcapsules and the included area within each pixel element.

A transparent common electrode 26 positioned on one side of electrophoretic ink 24 comprises, for example, a transparent conductive material such as indium tin oxide that allows topside viewing of electrophoretic display 10. Common electrode 26 does not need to be patterned. Electrophoretic ink 24 and common electrode 26 may be covered with a transparent protective layer 28 such as a thin layer of polyethylene. An adhesive substance may be disposed on the other side of electrophoretic ink 24 to allow attachment to a backplane 32. The layer of electrophoretic ink 24 may be glued, adhered, or otherwise attached to backplane 32. Backplane 32 comprises a plastic, glass, ceramic or metal backing layer having an array of addressable pixel electrodes and supporting electronics. In an alternative embodiment, the pixel electrodes and the common electrode may be arranged on the same substrate, whereby an in-plane electric field may be generated to move particles in an in-plane direction.

When the layer of electrophoretic ink 24 is attached to backplane 32, individual pixel electrodes 36 on backplane 32 allow a predetermined charge 34 to be placed onto one or more electrophoretic pixels 22. The electric field resulting from charge 34 causes transitions from one optical state to another of electrophoretic ink 24. The electric field generates a force to re-orient and/or displace charged particles in the layer of electrophoretic ink 24, providing a black and white or variable color display from which text, graphics, images, photographs and other image data can be presented. Gray tones or specific colors of electrophoretic ink 24 can be achieved, for example, by controlling the magnitude, level, location and timing of the activation voltage and associated charge 34.

Addressing of electrophoretic ink 24 is accomplished by applying an activation voltage to one or more pixel electrodes 36, placing a predetermined amount of charge 34 thereon and switching electrophoretic ink 24 to the desired optical state. Application and storage of charge 34 onto a pixel electrode 36 allows continued activation of the electrophoretic ink 24 when the activation voltage is removed, even if activation occurs on a slower time scale than the scanning process. The short-term storage effect of charge on the pixel electrodes 36 allows scanning of other rows of pixels while the image continues to form in the ink. Removal of the applied activation charge 34 quenches or immobilizes electrophoretic ink 24 at the achieved optical state.

For example, electrophoretic ink 24 may be switched from white to black. In another example, an initially black optical state is switched controllably to a gray or white state. In another example, a white optical state is switched to a gray optical state. In yet another example, colored electrophoretic ink switches from one color to another based on the activation voltage and the activation charge 34 applied to pixel electrodes 36. After addressing and switching have been completed, electrophoretic displays incorporating electrophoretic ink 24 continue to be viewable with no additional power consumption.

Electrophoretic pixels 22 are addressable, for example, with a thin-film transistor array on backplane 32 and associated row and column drivers that place predetermined charge 34 onto pixel electrodes 36 of electrophoretic pixel 22 for a prescribed time to reach the desired optical state. The charge is subsequently removed to retain electrophoretic pixel 22 in the acquired optical state. Intermediate values of gray can be obtained by controlling the amount of activation time and the electric field intensity across electrophoretic pixel 22. When the electric field is removed, the particles remain in the acquired optical state, and the image written to electrophoretic display 10 is retained, even with removal of electrical power.

Sections or tiles of electrophoretic display 10 of various sizes may be assembled together or placed side-by-side to form nearly any desired size of electrophoretic display that can be mounted, for example, on panels or other large surfaces. Electrophoretic display 10 may be formed with a size, for example, of a few centimeters on a side to as large as one meter by one meter or larger. Electrophoretic displays 10 with associated driver electronics may be used, for example, in monitors, laptop computers, personal digital assistants (PDAs), mobile telephones, electronic books, electronic newspapers and electronic magazines.

FIG. 2 is a schematic view of a system 12 for activating an electrophoretic display 10, in accordance with one embodiment of the present invention. The system includes an electrophoretic display 10 having an electrophoretic pixel array 20 containing individually addressable electrophoretic pixels 22 disposed on a display panel or backplane 32, a controller 30, a row driver 40, and a column driver 50. Row driver 40 is electrically connected via row electrodes 42 to rows 44 of electrophoretic pixel array 20. Column driver 50 is electrically connected via column electrodes 52 to columns 54 of electrophoretic pixel array 20. Controller 30 is electrically connected to row drivers 40 and column drivers 50. Controller 30 sends command signals to row drivers 40 and column drivers 50 to address electrophoretic pixels 22. A memory may be coupled to or contained within controller 30 to store items such as image data, image-independent driving waveform information, image-dependent driving waveform information, data-frame times, and pixel data.

Electrophoretic pixels 22 are activated by applying an activation potential and placing a predetermined charge 34 onto one side of electrophoretic pixel 22 when electrophoretic pixel 22 is addressed by the row driver 40 and the column driver 50, while common electrode 26 is biased at zero volts or at another suitable potential. Electrophoretic pixel 22 with common electrode 26 on one side and pixel electrode 36 on the other forms a capacitor that can be charged or discharged to the desired level. While charged, electrophoretic pixel 22 will transition from one optical state to another. Additional capacitance may be added in parallel with each electrophoretic pixel 22 to increase charge storage capability. In one example, row drivers 40 and column drivers 50 cooperate with controller 30 to supply activation voltages with a positive amplitude, a negative amplitude, or zero amplitude to selected electrophoretic pixels 22, thereby transferring positive charge, negative charge, or no charge onto the associated pixel electrodes.

Electrophoretic pixels 22 of electrophoretic pixel array 20 are arranged in a row-column format that allows selection of rows 44 sequentially in turn while image data corresponding to each electrophoretic pixel 22 in the selected row is placed on column electrodes 52. Each electrophoretic pixel 22 in electrophoretic pixel array 20 is electrically connected on one side to a common electrode 26 that is referenced, for example, to ground or 0 volts. A predetermined charge 34 may be placed on a pixel electrode 36 on the other side of electrophoretic pixel 22 to drive electrophoretic pixel 22 to the desired optical state. For example, a positive charge 34 placed on electrophoretic pixel 22 causes the pixel to become white, whereas a negative charge 34 placed on electrophoretic pixel 22 causes the pixel to become dark. Discharging or otherwise removal of the charge freezes the electrophoretic pixel at the acquired optical state.

An array of active switching elements such as thin-film transistors 38 allows the desired charge 34 to be placed on one side of electrophoretic pixel 22. A row driver 40 is connected via row electrodes 42 to rows 44 of electrophoretic display 10. Each row electrode 42 is connected to the gates of a row of thin-film transistors 38, allowing transistors 38 in the row to be turned on when the row voltage is raised above a turn-on voltage. The row driver 40 sequentially selects row electrodes 42, while a column driver 50 provides data signals to column electrodes 52. The column driver 50 is connected to column electrodes 52 of electrophoretic display 10. Each column electrode 52 is connected to the sources of a column of thin-film transistors 38. This arrangement of pixels, transistors 38 and row and column electrodes jointly forms an active matrix. The row driver 40 supplies a selection signal for selecting a row 44 of electrophoretic pixels 22 and the column driver 50 supplies data signals to the selected row 44 of electrophoretic pixels 22 via column electrodes 52 and transistors 38.

Preferably, controller 30 first processes incoming image information 14 and generates the data signals and driving waveforms. Mutual synchronization between the row driver 40 and the column driver 50 takes place via electrical connections with controller 30. Selection signals from the row driver 40 select one or more rows 44 of pixel electrodes 36 via transistors 38. Transistors 38 have drain electrodes that are electrically coupled to pixel electrodes 36, gate electrodes that are electrically coupled to the row electrodes 42, and source electrodes that are electrically coupled to the column electrodes 52. Data signals present at column electrodes 52 are simultaneously transferred to pixel electrodes 36 coupled to the drain electrodes of turned-on transistors 38. The data signals and the row selection signals together form at least a portion of a driving waveform. The data signals correspond to data to be displayed, and form, together with the selection signals, a driving waveform for driving one or more electrophoretic pixels 22 in the electrophoretic pixel array 20. The composite time for the driving waveform represents an image update period wherein a new image may be written or refreshed.

The magnitude and polarity of charge 34 placed on each electrophoretic pixel 22 depends on the activation voltage applied to pixel electrodes 36. In one example, a negative voltage, zero voltage, or a positive activation voltage may be placed on each column such as −15V, 0V and 15V. As each row 44 is selected, charge 34 may be placed or removed from each pixel electrode 36 in the row based on the column voltage. For example, a negative charge, positive charge or zero charge may be placed on pixel electrode 36 of electrophoretic pixel 22 to switch the optical state accordingly. As the next row 44 is addressed, charges 34 on previously addressed pixels continue to reside on pixel electrodes 36 until updated with a subsequent driving waveform or are otherwise discharged.

Grayscale writing of image data to electrophoretic display 10 may be accomplished by sustaining a predetermined charge 34 on electrophoretic pixel 22 for a series of one or more data frames. Each data frame comprises pixel data and corresponding pixel address information for each row 44 in the display. The time interval to sequentially address all rows 44 in the display once with display information constitutes the data-frame time. To supply image-independent signals to electrophoretic pixels 22 during frames, controller 30 controls the column driver 50 so that all electrophoretic pixels 22 in a row 44 receive the image-independent signals simultaneously. This is done row by row, with controller 30 controlling the row driver 40 in such a way that the rows are selected one after the other, e.g. all transistors 38 in the selected row are brought into a conducting state. To supply image-dependent signals to electrophoretic pixels 22 during a frame, controller 30 controls the row driver 40 so that each row is selected in turn, e.g. all transistors 38 in the selected row are brought into a conducting state, while controller 30 also controls the column driver 50 so that electrophoretic pixels 22 in each selected row 44 receive the image-dependent signals simultaneously via associated transistors 38. Controller 30 provides row driver signals to the row driver 40 to select a specific row 44 and provides column driver signals to the column driver 50 to place the desired voltage level and corresponding charge 34 onto each electrophoretic pixel 22 in the selected row 44. Controller 30 may provide data frames adapted to reset electrophoretic display 10 to a predetermined optical state.

Subsequent frames may contain the same display information or updated display information with additional pixel data. The grayscale levels of a specific pixel is determined by the number of consecutive frames with the same content, such as between zero and fifteen adjacent frames with a positive or negative charge 34 applied to pixel electrode 36 after electrophoretic pixel 22 has been reset to a white or black optical state. Each frame has identical data-frame times, resulting in sixteen levels of grayscale resolution per pixel. In another example, the grayscale resolution is increased with alterations of the frame time for one or more frames. In yet another example, inserting additional data frames at appropriate locations between symmetric data frames increases the grayscale resolution and accuracy. To ensure uniformity of the written image between the first row and the last row of electrophoretic display 10 with variable frame times, symmetric data frames may be used to ensure that pixels in the first row have the same activation time as pixels in the last row to minimize or reduce vertical crosstalk. The symmetric data frames may include null pixel data (zeros) or non-zero pixel data The symmetric data frames may comprise either image-dependent or image-independent information.

Controller 30 processes incoming data, such as image information 14 receivable via image input 16. Controller 30 detects an arrival of new image information 14 and in response starts the processing of the received image information 14. Processing of image information 14 may include loading new image information 14, comparing the new image information 14 to previous image information stored in a memory coupled to controller 30, accessing of memories containing look-up tables of drive waveforms, or interacting with onboard temperature sensors (not shown) to compensate for switching time variations with temperature. Controller 30 detects when processing of image information 14 is ready and electrophoretic pixel array 20 can be addressed.

Controller 30, such as a microprocessor, a microcontroller, a field-programmable gate array (FPGA), or other digital device may receive and execute microcoded instructions to address and write a desired image onto electrophoretic display 10. Controller 30 sends row selection signals to the row driver 40 and data signals to the column driver 50 to activate electrophoretic display 10. Controller 30 may be contained within a personal computer (PC), a laptop computer, a personal digital assistant (PDA), an electronic book, or other digital device and connected to electrophoretic display 10. Alternatively, controller 30 is contained within electrophoretic display 10 attached to backplane 32.

Controller 30 generates the data signals that are supplied to the column driver 50, and generates the row selection signals that are supplied to the row driver 40. Data signals supplied to the column driver 50 may include an image-independent portion and an image-dependent portion. Image-independent portions of the driving waveform include signals that are identically applied to some or all electrophoretic pixels 22 in electrophoretic pixel array 20 such as reset pulses or preconditioning pulses. Image-dependent portions of the driving waveform include image information and may or may not vary between individual electrophoretic pixels 22.

With reference to elements described in further detail in FIGS. 3, 4, and 5, controller 30 generates a plurality of symmetric data frames 70 including symmetric pixel data 72 and substantially symmetric data-frame times 74 from received image information 14 and addresses electrophoretic pixel array 20 based on symmetric pixel data 72 and substantially symmetric data-frame times 74 of symmetric data frames 70 to minimize or reduce vertical crosstalk Image information 14 is received via input 16 to controller 30. Based on image information 14 and other input such as temperature input, controller 30 may adjust symmetric data-frame time 74 of symmetric data frames 70 to provide increased grayscale accuracy. Controller 30 determines symmetric data frames 70 based on image information 14 during image-independent or image-dependent portions of the driving waveform.

Controller 30 addresses the row driver 40 and the column driver 50 based on symmetric pixel data 72 and substantially symmetric data-frame times 74 of symmetric data frames 70 to activate one or more electrophoretic pixels 22 in electrophoretic pixel array 20. The contents of symmetric data frames 70 including symmetric data-frame time 74 may be determined by controller 30 operating and executing associated code. Controller 30 provides two or more symmetric data frames 70 including symmetric pixel data 72 and symmetric data-frame time 74 to electrophoretic pixel array 20. Controller 30 may send serial or parallel symmetric pixel data 72 and symmetric data-frame times 74 of symmetric data frames 70 to the row driver 40 and the column driver 50 to activate electrophoretic pixel array 20.

Controller 30 may use one or more symmetric data frames 70 to reset electrophoretic display to a predetermined optical state. After an image is written, controller 30 may address and update electrophoretic display 10 with additional symmetric data frames 70 in image-dependent or image-independent portions of the driving waveform. When an image has been written, controller 30 may power off or power down electrophoretic display 10 and associated circuitry, while electrophoretic display 10 retains the image written thereon.

Image information 14 may be provided to controller 30 from a parallel or serial connection with a digital computing device, video camera, or other source of display information. With reference to numbered elements described in more detail with FIGS. 3, 4 and 5, the provided display data may include symmetric pixel data 72 and symmetric data-frame time 74 with each symmetric data frame 70. Alternatively, controller 30 may generate symmetric pixel data 72 and symmetric data-frame time 74 for each symmetric data frame 70 after receiving image information 14 in any suitable display format.

With a high clock speed, controller 30 may adjust symmetric data-frame time 74 of symmetric data frame 70 to provide increased grayscale resolution and increased accuracy. Electrophoretic display 10 may be reset to a predetermined optical state such as all black, all white, or a pre-specified color or gray level by addressing and switching each electrophoretic pixel 22 in electrophoretic pixel array 20. With subsequently provided image information 14, electrophoretic display 10 may be updated with additional pixel data 72 by addressing and writing onto electrophoretic pixels 22 in electrophoretic display 10. When electrophoretic display 10 is not addressed or a portion or all of system 12 is powered down or powered off, electrophoretic display 10 retains and displays the previously written image.

In one embodiment described in further detail with FIG. 4, higher grayscale resolution, higher grayscale accuracy, and the reduction or elimination of vertical crosstalk are achieved for electrophoretic display 10 by generating a driving waveform having symmetric data-frame times 74 that decrease toward a midpoint 66 of an image-dependent portion of a driving waveform. In another embodiment presented in further detail with FIG. 5, symmetric data-frame times 74 increase toward midpoint 66 of an image-dependent portion of a driving waveform. In another embodiment, symmetric data-frame times 74 are symmetrically positioned about a midpoint of an image-dependent portion of a driving waveform. In another embodiment, symmetric frame time 74 of a first symmetric data frame 70 and symmetric data-frame time 74 of a last symmetric data frame 70 in a plurality of symmetric data frames 70 are equal. The number of levels of gray can be increased and the grayscale accuracy is improved, while unintended and inaccurate gradation of grayscale from the first row to the last row of the display is avoided.

To account for temperature changes within the display and to mitigate variations in switching time with temperature, a temperature sensor (not shown) may be included on or near backplane 32. Temperature effects may be compensated, for example, by scaling symmetric data-frame times 74 in accordance with the current operating temperature of electrophoretic display 10.

FIG. 3 is described with reference to previously described numbered elements of FIGS. 1 and 2. FIG. 3 is a timing diagram illustrating a method of activating an electrophoretic display using variable data-frame times. Data-frame time 74 of one or more data frames 70 is adjusted to provide increased grayscale resolution and accuracy.

Electrophoretic display 10, as shown previously in FIGS. 1 and 2, may be driven with higher grayscale resolution and accuracy by adjusting data-frame times 74 when addressing electrophoretic pixels 22 and by creating sequences of data frames 70 in which at least two data-frame times 74 in the sequence of data frames 70 have a different data-frame time. The number of possible grayscale levels is increased, and the grayscale values can be generated more accurately. Data-frame times 74 are adjusted, for example, by delaying the start of next data frame 70 or by adjusting the time interval between addressing various rows of electrophoretic display 10.

A series of data frames 70 represented by adjacent data frames 70a, 70b and 70c contain pixel data 72a, 72b and 72c associated with each electrophoretic pixel 22 in rows 44a, 44b, . . . 44n of electrophoretic display 10. Each data frame 70 includes an adjustable data-frame time 74 represented by data-frame times 74a, 74b and 74c, respectively. As time progresses, pixel data 72 and data-frame time 74 are applied to associated columns in the display on a row-by-row basis. In the example illustrated, data-frame time 74a of data frame 70a is longer than data-frame time 74b of data frame 70b, which in turn is longer than data-frame time 74c of data frame 70c. Consequently, the activation time for electrophoretic pixels 22 in row 44n is less than corresponding electrophoretic pixels 22 in row 44a, resulting in a nonlinearity in response time between first row 44a and last row 44n and other rows in between. To compensate for this effect while allowing adjustable frame times, symmetric data frames may be inserted between selected frames. Thus, vertical crosstalk may be avoided by introducing symmetric data frames into strategic portions of the driving waveform, such as about a midpoint of an image-dependent portion or an image-independent portion of the driving waveform to provide a uniform displayed image with an accurate and large number of gray levels.

FIG. 4, which is described with referenced elements of FIGS. 1 and 2, is a timing diagram illustrating a method of activating an electrophoretic display 10 using symmetric data frames 70, in accordance with one embodiment of the present invention. Electrophoretic display 10 is addressed using symmetric data frames 70 with symmetric data-frame times 74 that decrease toward a midpoint 66 of an image-dependent or an image-independent portion of a driving waveform. Symmetric data frames 70 have symmetric data-frame times 74 about midpoint 66. Symmetric pixel data 72 provides equal activation time for electrophoretic pixels 22 in each row 44 of electrophoretic display 10.

In this example, symmetric data frames 70 represented by symmetric data frames 70a, 70b, 70c, 70d, 70e and 70f with associated symmetric data-frame times 74a, 74b, 74c, 74d, 74e and 74f, respectively and associated symmetric pixel data 72a, 72b, 72c, 72d, 72e and 72f, respectively. Symmetric data frames 70a, 70b, 70c, 70d, 70e and 70f are positioned symmetrically about midpoint 66 and are applied sequentially to rows 44a, 44b, . . . 44n to drive each electrophoretic pixel 22 in electrophoretic pixel array 20 to the desired optical state. Data-frame time 74a and data-frame time 74f are equal, data-frame time 74b and data-frame time 74e are equal, and data-frame time 74c and data-frame time 74d are equal. Data-frame times 74b and 74e are shorter than data-frame times 74a and 74f, and data-frame times 74c and 74e are shorter than data-frame times 74b and 74e, while providing symmetry about midpoint 66. Symmetric data frames 70 with symmetric pixel data 72 contain pixel data that can alter the optical state of the corresponding pixel elements and provides each row 44a, 44b . . . 44n with identical activation times for transitioning electrophoretic pixels 22. Consequently, variations of data-frame times 74, as symmetrically applied, do not result in non-uniformities between rows 44 of electrophoretic display 10.

Symmetric pixel data 72 allows pixels in any row of electrophoretic pixel array 20 to reach identical gray levels by placing pixel data 72 into appropriate frames so that the sum of the frame times for a row 44 is the same for any other row 44 to avoid vertical crosstalk For example, identical pixel data 72 is placed into symmetric data frames 70b and 70d, resulting in the same activation time for first row 44a and last row 44n, and other rows in between. In another example, identical pixel data 72 is placed into symmetric data frames 70a and 70e to achieve a constant activation time for the pixel data independent of any row 44. To achieve the desired number of grayscale levels and accuracy while minimizing vertical crosstalk, this procedure may be applied to additional sets of symmetric data frames 70 positioned symmetrically about midpoint 66 for any combination of symmetric pixel data 72.

Null pixel data may be inserted into pixel data 72c of data frame 70c. Alternatively, pixel data 72c corresponding to positive or negative activation voltages and positive or negative charge 34 on pixel electrodes 36 may be used to activate electrophoretic ink 24 and to provide increased grayscale resolution and accuracy.

With portable electrophoretic displays 10, power consumption is an important consideration. With adjacent data frames 70c and 70d having the shortest data-frame times 74c and 74d, local power consumption near midpoint 66 indicated by the emboldened arrow 68 can be relatively high.

FIG. 5, which is described with referenced elements of FIGS. 1 and 2, is a timing diagram illustrating a method of activating an electrophoretic display using symmetric data frames, in accordance with another embodiment of the present invention. Electrophoretic display 10 is addressed with a plurality of symmetric data frames 70 having symmetric data-frame times 74 that increase toward midpoint 66 of an image-dependent or an image-independent portion of a driving waveform.

In this example, symmetric data frames 70 are represented by symmetric data frames 70a, 70b, 70c, 70d, 70e and 70f with associated symmetric data-frame times 74a, 74b, 74c, 74d, 74e and 74f, respectively and associated symmetric pixel data 72a, 72b, 72c, 72d, 72e and 72f, respectively. Symmetric data frames 70a, 70b, 70c, 70d, 70e and 70f are positioned symmetrically about midpoint 66 and are applied sequentially to rows 44a, 44b, . . . 44n to drive each electrophoretic pixel 22 in electrophoretic pixel array 20 to the desired optical state. Data-frame time 74a and data-frame time 74f are equal, data-frame time 74b and data-frame time 74e are equal, and data-frame time 74c and data-frame time 74d are equal. Data-frame times 74b and 74e are longer than data-frame times 74a and 74f, and data-frame times 74c and 74e are longer than data-frame times 74b and 74e, and together provide symmetry about midpoint 66. This embodiment reduces the local power dissipation about midpoint 66 relative to FIG. 4. Symmetric data frames 70 with symmetric pixel data 72 contain pixel data that can alter the optical state of the corresponding pixel elements and provide each row 44a, 44b, . . . 44n with identical activation times for transitioning electrophoretic pixels 22. Consequently, variations of data-frame times 74, as symmetrically applied, do not result in non-uniformities between rows 44 of electrophoretic display 10.

In another embodiment, symmetric data-frame times 74 are symmetrically positioned about midpoint 66, allowing data-frame times 74 that vary shorter or longer on each side of midpoint 66 although each has a corresponding and similarly sized data-frame time 74 symmetrically positioned on the other side of midpoint 66.

In another embodiment, symmetric data-frame time 74 of a first symmetric data frame 70 and symmetric data-frame time 74 of a last symmetric data-frame time 74 in a plurality of data frames 70 are equal.

Symmetric data frames 70 having symmetric data-frame times 74 that increase towards, decrease towards, or are otherwise symmetric about midpoint 66 may be used in image-dependent or an image-independent portions of a driving waveform. Symmetric data frames 70 may be inserted one or more times within the driving waveform.

FIG. 6, which is described with referenced elements of FIGS. 1 through 5, illustrates a driving waveform 60 for activating electrophoretic display 10 with symmetric data frames in an image-dependent portion of the driving waveform, in accordance with one embodiment of the present invention. Driving waveform 60 represents voltages across electrophoretic pixel 22 in electrophoretic display 10 as a function of time t. The waveform is applied to electrophoretic pixels 22 using row selection signals from the row driver 40 and data signals supplied via the column driver 50. Driving waveform 60 comprises, for example, a column driving signal and a row selection signal for providing preconditioning or shaking pulses, one or more reset signals, and data signals associated with each optical state and transitions thereto. Data frames 70 are symmetrically applied about a midpoint 66 in an image-dependent portion of driving waveform 60 represented by symmetric data frames 70a, 70b, 70c, 70d, 70e and 70f. Symmetric data frames may also be introduced into image-independent portions of driving waveform 60, such as preconditioning portion 62 and reset portion 64.

Driving waveform 60 comprises multiple frames, including an image-dependent portion with a plurality of symmetric data frames 70. Driving waveform 60 also includes an image-independent portion comprising, for example, one or more preconditioning portions 62, a reset portion 64, or a combination thereof. The timing for image-dependent data frames 70, preconditioning portions 62, and reset portions 64 is intended to be illustrative and is not necessarily to scale. The time interval required to address pixels of all rows once by driving each row one after the other and by driving all columns simultaneously once per row is data-frame time 74, as illustrated in FIGS. 3, 4, and 5. During each data frame 70, image-dependent or image-independent data is supplied to one or more electrophoretic pixels 22 in the array. Driving waveform 60 comprises, for example, a series of preconditioning shaking pulses followed by a series of reset pulses, additional shaking pulses, and a combination of driving pulses to drive the electrophoretic pixel into the desired optical state.

For example, an electrophoretic display 10 with four gray levels may have sixteen different driving waveforms 60 stored in a lookup table in a memory electrically connected to or part of controller 30. From an initial black state, four different driving waveforms 60 allow the initially black pixel to be optically switched to black, dark gray, light gray, or white. From an initially dark-gray state, four different driving waveforms 60 allow the initially dark-gray pixel to be optically switched to black, dark gray, light gray, or white. Additional driving waveforms 60 allow a light gray or a white pixel to be switched to any of the four gray levels. In response to image information 14 received via image input 16, controller 30 may select the corresponding driving waveform 60 from a lookup table for one or more electrophoretic pixels 22, and supply the corresponding row selection signals and column data signals via the row driver 40 and column drivers 50 to corresponding transistors 38 connected to corresponding pixel electrodes 36.

To reduce the dependency of the optical response of electrophoretic display 10 on the image history of the pixels, preconditioning signals may be applied to electrophoretic pixels 22 prior to reset signals or image-dependent signals. Preconditioning allows electrophoretic pixels 22 to switch faster with higher uniformity of transitions between one optical state and another. During preconditioning portions 62 of driving waveform 60, alternating pulses of positive and negative voltage, sometimes referred to as shaking pulses, are applied to one or more electrophoretic pixels 22 of the display in preparation for subsequent optical state transitions. For example, alternating positive and negative voltages are applied sequentially to the pixels. These preconditioning signals may comprise applying alternating voltage levels to electrophoretic pixels that are sufficient to release the electrophoretic particles from a static state at one or both electrodes, yet either sum to zero or are too short to significantly alter the current positions of the electrophoretic particles or the optical state of the pixel.

Because of the reduced dependency on the image history, the optical response of pixels to new image data are substantially independent of whether the pixel was previously black, white or gray. The application of the preconditioning signals reduces the dependency and allows a shorter switching time.

For example, during the initial portion of driving waveform 60, a first set of frames comprising the pulses of the preconditioning signals are supplied to the pixels, each pulse having a duration of one frame period. The first shaking pulse has a positive amplitude, the second shaking pulse has a negative amplitude, and the third shaking pulse has a positive amplitude with additional pulses in an alternating sequence until preconditioning portion 62 is completed. As long as the duration of these pulses is relatively short or that the pulses are applied in rapidly changing positive and negative levels, the pulses do not change the gray value displayed by the pixel.

During a reset portion 64 of driving waveform 60, electrophoretic display 10 is reset to a predetermined optical state, such as an all-black state, an all-white state, a gray-scale state, or a combination thereof. The reset pulses within reset portion 64 precede the image-dependent pulses to improve the optical response of electrophoretic display 10 by defining a fixed starting point such as black, white, or an intermediate level for the image-dependent pulses. For example, the starting point is selected based on previous image information or the closest gray level to new image data. In this case, the reset signal is an image-dependent data signal. A set of frames comprising one or more frame periods is supplied including pixel data associated with the desired optical state. The activation voltage and activation charge 34 may be applied for a time longer than is required to fully switch the addressed portions of electrophoretic display 10 to the initialized optical state, and then may be removed. Alternatively, electrophoretic display 10 may be reset with a positive or a negative voltage applied to common electrode 26 while pixel electrodes 36 are maintained at a low voltage or near ground potential. To set electrophoretic pixels 22 at the desired optical state, symmetric data frames 70 may be used.

After reset portion 64 of driving waveform 60 has been applied, electrophoretic pixels 22 appear in the predetermined optical state to the viewer. An additional preconditioning portion 62 may be applied to one or more electrophoretic pixels 22 after application of reset portion 64 in preparation for writing or updating an image to the display. Prior to addressing the display with image-dependent data, an additional preconditioning portion 62 may be added after reset portion 64 to prepare the pixels for receiving image-dependent frame data.

During the image-dependent portion of driving waveform 60, a set of data frames comprising two or more symmetric frame periods is generated and supplied. The image-dependent signals have duration, for example, of zero, one, two, through fifteen frame periods or more with non-zero data signals corresponding to sixteen or more grayscale levels. When starting with a pixel in a black optical state, an image-dependent signal having a null data or equivalently a duration of zero frame periods corresponds with the pixel continuing to display black. In the case of a pixel displaying a specific gray level, the gray level remains unchanged when being driven with a pulse having a duration of zero frame periods or with a sequence of pulses having zero amplitude. An image-dependent signal having a duration of fifteen frame periods comprises fifteen subsequent pulses and corresponds to, for example, the pixel transitioning to and displaying white. An image-dependent signal having a duration of one to fourteen frame periods comprises one to fourteen subsequent pulses and corresponds to, for example, the pixel displaying one of a limited number of gray values between black and white. Data signals and data-frame times may be symmetrically applied about a midpoint of two or more data frames within the image-dependent portion of driving waveform 60.

The electrophoretic display is updated with image information converted and applied as symmetric pixel data to each pixel in the display on a row-by-row basis with two or more symmetric data frames 70, represented as symmetric data frames 70a, 70b, 70c, 70d, 70e and 70f with symmetric pixel data 72a, 72b, 72c, 72d, 72e and 72f, respectively, and symmetric data-frame times 74a, 74b, 74c, 74d, 74e and 74f, respectively. In the example shown, data-frame times of symmetric data frames 70a through 70f increase in time towards midpoint 66 of driving waveform 60. Alternatively, symmetric data-frame times may decrease in time towards midpoint 66 or otherwise be symmetrically disposed about midpoint 66 with variations in frame time. Data-frame times 74 associated with data frames 70 may be adjusted to provide increased grayscale resolution and accuracy. Controller 30 may adjust data-frame time 74 of any frame in driving waveform 60 to improve the grayscale resolution or to reach a specific gray level, such as by adjusting the number of clock cycles between the start of a row selection signal and the start of the next row selection signal, or by adjusting the overall system clock speed as applied to the row driver 40.

Electrophoretic display 10 may be updated with additional symmetric pixel data supplied with subsequently applied driving waveforms 60. For example, to update electrophoretic pixels 22 in electrophoretic display 10, a row selection signal is applied sequentially to each row 44 of the display, while pixel data 72 for electrophoretic pixels 22 in each row is applied to columns connected to pixel electrodes 36. Positive charge, negative charge, or no charge is transferred onto the pixel electrodes 36 in accordance with the frame data, and electrophoretic pixels 22 respond accordingly with a darker state, a lighter state, or no change.

To activate electrophoretic display 10, controller 30 may execute a computer program to convert image information into a series of driving waveforms 60 and address the display accordingly. The computer program includes computer program code to receive image information, to generate a plurality of symmetric data frames including symmetric pixel data and substantially symmetric data-frame times, and to address the electrophoretic display based on the symmetric pixel data and the substantially symmetric data-frame times. The computer program may also contain computer program code to adjust the symmetric data-frame time of the symmetric data frames to provide increased grayscale resolution, reduce vertical crosstalk and increase grayscale accuracy, to reset the electrophoretic display to a predetermined optical state, to update the electrophoretic display with additional symmetric data frames, and to power off or otherwise power down the electrophoretic display while retaining an image written to the electrophoretic display.

FIG. 7 is a flow diagram for a method of activating an electrophoretic display, in accordance with one embodiment of the present invention. The activation method includes steps to activate and update an electrophoretic display with an active matrix using symmetric data frames.

Image information is received, as seen at block 80. Image data may be received from a memory device such as a memory stick, or an uplink from a PC, laptop computer or PDA that is optionally connected to a controller electrically coupled to the electrophoretic display. Image information may be received via a wired or wireless link from any suitable source such as a video feed, an image server, or a stored file. The controller may be connected to a communications network such as a local area network (LAN), a wide-area network (WAN), or the Internet to receive and send information and to transfer images onto the electrophoretic display. The image information may be provided in real time as the image is written to the electrophoretic display, or stored within memory until written. When image information is received, the image data is processed to generate and provide a plurality of symmetric data frames including symmetric pixel data and substantially symmetric data-frame times to activate the electrophoretic display.

The electrophoretic display may be preconditioned and reset to a predetermined optical state, as seen at block 82. Before an image is written, electrophoretic ink of the display material may be reset to a well-defined state. The electrophoretic ink can be forced into an initialized or reset optical state through an applied electric field with, for example, the sustained application of relatively high activation voltage applied to the electrophoretic pixels via the pixel electrodes or to the common electrode. When the electrophoretic display is reset, one or more pixels are reset to the predetermined optical state.

The electrophoretic ink is reset, for example, to an all-white, all-black, gray, or colored optical state, depending on the type of electrophoretic ink and the applied activation voltage. Initialization of the electrophoretic ink is accomplished, for example, with application of a positive supply voltage to switch the electrophoretic particles within the electrophoretic ink to the initialized state, while the transparent common electrode is set or retained at a specified potential such as ground. From this initialized or reset optical state, the electrophoretic ink can be adjusted in one common direction or another based on the driving forces applied to the electrophoretic pixels. The electrophoretic display may be initialized or reset with a pattern similar to the image to be written, so that only a fraction of the total switching time for the electrophoretic ink is needed to write the image with the desired grayscale resolution and accuracy. Similar to the data-dependent portion of the driving waveform, the electrophoretic display may be reset with a plurality of image-independent symmetric data frames including symmetric pixel data and symmetric data-frame times. The electrophoretic display may be stored in the initialized state for an indeterminate period of time or written upon forthwith.

Prior to resetting the display, the display may be preconditioned with the application of one or more shaking or preconditioning pulses. Shaking pulses are applied to the electrophoretic pixels to precondition the electrophoretic pixels for receiving pixel data or for switching to a reset state. The electrophoretic ink is preconditioned, for example, with the application of an alternating activation voltage applied to pixel electrodes in the display. After resetting the display and prior to writing the image, the display may be preconditioned once again with the application of additional shaking pulses.

The symmetric data-frame times of one or more sets of symmetric data frames may be adjusted and a plurality of symmetric data frames including symmetric pixel data and substantially symmetric data-frame times is generated from the received image information, as seen at block 84. The symmetric data-frame time of the symmetric data frames may be adjusted to provide increased grayscale accuracy and to minimize vertical crosstalk. To achieve the desired gray levels and increase the grayscale resolution, the symmetric data-frame times may be adjusted longer or shorter.

When the data-frame time is adjusted, the data frames are symmetrically arranged about a midpoint in a portion of a driving waveform. The data-frame time of one data frame is set equal to the data-frame time of a symmetrically placed data frame. In one example, the symmetric data-frame times decrease toward a midpoint of an image-dependent portion of a driving waveform. In another example, the symmetric data-frame times increase toward a midpoint of an image-dependent portion of a driving waveform. In another example, the symmetric data-frame times are symmetrically positioned about a midpoint of an image-dependent portion of a driving waveform. In another embodiment, the symmetric data-frame time of a first symmetric data frame and the symmetric data-frame time of a last symmetric data frame in a plurality of symmetric data frames are equal. Symmetric data frames may be inserted at least once within a driving waveform.

The electrophoretic display is addressed based on the symmetric pixel data and the substantially symmetric data-frame times, as seen at block 86. When the electrophoretic display is addressed and an image is transferred to the electrophoretic display, an activation voltage is applied to one or more electrophoretic pixels and a predetermined charge is placed on corresponding pixel electrodes based on the symmetric pixel data and the symmetric data-frame times. The activation voltage is selected to switch selected portions of the electrophoretic display from the reset state or a previous optical state to the desired optical state. As charge is placed on pixel electrodes, the electrophoretic ink is activated and switches to the desired optical state. When the predetermined charge is placed across the pixels of the electrophoretic display, the electrophoretic ink continues to transition to an intended display state as long as the activation voltage is applied or the applied charge is retained on a pixel electrode. Based on the number, length and content of data frames, the electrophoretic ink is provided sufficient time to switch optical states in the designated pixels. The desired optical state for the electrophoretic display can be locked in or frozen by removal of the activation charge and the activation voltage from pixels in the display.

Symmetric data frames may be inserted one or more times within a driving waveform. Driving waveforms containing one or more symmetric data frames may be generated or selectively extracted, for example, from a lookup table stored in memory and provided to the electrophoretic display.

After the desired image has been written to the electrophoretic display, the image may be viewed. Further refreshing or writing of new images may occur as desired within, for example, a portion of a second, minutes, hours, days, weeks or even months after writing previous images.

The electrophoretic display may be updated with additional symmetric pixel data, as seen at block 88. New image data may be received, and the electrophoretic display updated accordingly by repeating the above steps of blocks 80 through 86. Alternatively, the display may require refreshing, and previous image data may be re-sent to the display.

When no refreshing or updating of the image is required, circuitry may be powered down or turned off, the electrophoretic display may be powered off or otherwise placed in a power-down mode, as seen at block 90. When powered off or powered down, the electrophoretic display retains the image previously written to the display, unless written over with a black, white or other predetermined screen image.

While the embodiments of the invention disclosed herein are presently considered to be preferred, various changes and modifications can be made without departing from the spirit and scope of the invention. For example, the polarity of preconditioning and reset voltages, the data-frame times, the length of the driving waveform and the order of the portions included thereof, the number of gray levels, the size and number of pixel elements, the color of electrophoretic ink, and the thickness of the various layers have been chosen to be illustrative and instructive. The activation voltages, timing, color of the electrophoretic ink, scale and relative thickness of the included layers, pixel size, array size, and other materials and quantities may vary appreciably from that shown without departing from the spirit and scope of the claimed invention. The scope of the invention is indicated in the appended claims, and all changes that come within the meaning and range of equivalents are intended to be embraced therein.

1. A method of activating an electrophoretic display (10) while reducing vertical crosstalk the method comprising:
receiving image information (14);
generating a plurality of symmetric data frames (70) from the received image information, the symmetric data frames including symmetric pixel data (72) and substantially symmetric data-frame times (74); and
addressing the electrophoretic display based on the symmetric pixel data and the substantially symmetric data-frame times.

2. The method of claim 1, wherein the generated symmetric data frames comprise image-dependent symmetric data frames.

3. The method of claim 1, wherein the data-frame times are symmetric to minimize vertical crosstalk.

4. The method of claim 1, wherein the symmetric data-frame times decrease toward a midpoint (66) of an image-dependent portion of a driving waveform (60).

5. The method of claim 1, wherein the symmetric data-frame times increase toward a midpoint (66) of an image-dependent portion of a driving waveform (60).

6. The method of claim 1, wherein the symmetric data-frame times are symmetrically positioned about a midpoint (66) of an image-dependent portion of a driving waveform (60).

7. The method of claim 1, wherein the symmetric data frames are inserted more than once within a driving waveform (60).

8. The method of claim 1, further comprising:
adjusting the symmetric data-frame time of the symmetric data frames to provide increased grayscale accuracy.

9. The method of claim 1, further comprising:
resetting the electrophoretic display to a predetermined optical state.

10. The method of claim 9, wherein the electrophoretic display is reset with a plurality of image-independent symmetric data frames, the symmetric data frames including symmetric pixel data and symmetric data-frame times.

11. The method of claim 1, further comprising:
updating the electrophoretic display with additional symmetric data frames.

12. A system (12) for activating an electrophoretic display (10), the system comprising:
an electrophoretic pixel array (20) disposed on a backplane (32);
means for generating a plurality of symmetric data frames (70) from the received image information, the symmetric data frames including symmetric pixel data (72) and substantially symmetric data-frame times (74); and
means for addressing the electrophoretic pixel array based on the symmetric pixel data and the substantially symmetric data-frame times.

13. The system of claim 12, further comprising:
means for adjusting the symmetric data-frame time of the symmetric data frames to provide increased grayscale accuracy.

14. The system of claim 12, further comprising:
means for resetting the electrophoretic display to a predetermined optical state.

15. The system of claim 12, further comprising:
means for updating the electrophoretic display with additional symmetric data frames.

16. An electrophoretic display (10), comprising:
an electrophoretic pixel array (20) disposed on a backplane (32);
a row driver (40) electrically connected to rows (44) of the electrophoretic pixel array;
a column driver (50) electrically connected to columns (54) of the electrophoretic pixel array; and
a controller (30) electrically connected to the row driver and the column driver;
wherein the controller generates a plurality of symmetric data frames (70) from the received image information, the symmetric data frames including symmetric pixel data (72) and substantially symmetric data-frame times (74); and
wherein the controller addresses the electrophoretic display based on the symmetric pixel data and the substantially symmetric data-frame times to activate at least one electrophoretic pixel (22) in the electrophoretic pixel array.
